(19) United States
(12) Patent Application Publication
(10) Pub. No.: US 2026/0302444 A1
(43) Pub. Date: Oct. 1, 2026

(54) SECONDARY BATTERY, CASE FOR SECONDARY BATTERY, AND METHOD OF MANUFACTURING SECONDARY BATTERY

(71) Applicant: SAMSUNG SDI CO., LTD., Yongin-si (KR)

(72) Inventors: Sunyang HONG, Yongin-si (KR); Jeongchull AHN, Yongin-si (KR); Jong-Ha LEE, Yongin-si (KR); Jeongsoo LIM, Yongin-si (KR)

(21) Appl. No.: 19/563,077

(22) Filed: Mar. 11, 2026

(30) Foreign Application Priority Data
Mar. 28, 2025 (KR) 10-2025-0040283

(51) Int. Cl. H01M 50/145; H01M 10/04; H01M 10/0525; H01M 50/103; H01M 50/119; H01M 50/15; H01M 50/159; H01M 50/169

(52) U.S. Cl. CPC H01M 50/145; H01M 10/049; H01M 10/0525; H01M 50/103; H01M 50/119; H01M 50/15; H01M 50/159; H01M 50/169

(57) ABSTRACT

A case for secondary battery includes a body including an opening at one end and an accommodating space configured to accommodate an electrode assembly. A cover is coupled to body to cover the opening and seal the accommodating space. The body includes tin in an amount of 0.1 wt % or more and 0.5 wt % or less with respect to a total weight of the body.

### CROSS-REFERENCE TO RELATED APPLICATION

This application claims priority under 35 U.S.C. § 119 to Korean Patent Application No. 10-2025-0040283, filed in the Korean Intellectual Property Office on Mar. 28, 2025, the entire contents of which are hereby incorporated by reference.

### BACKGROUND

### Field

The present disclosure relates to a secondary battery, a case for secondary battery, and a method of manufacturing a secondary battery.

### Description of Related Art

Unlike primary batteries that cannot be recharged, secondary (or rechargeable) batteries can be discharged and recharged. Low-capacity secondary batteries are used in portable, small electronic devices, such as smart phones, feature phones, notebook computers, digital cameras, and camcorders. Large-capacity secondary batteries are widely used as power sources for driving motors in hybrid vehicles and electric vehicles and for storing power (e.g., home and/or utility scale power storage). A secondary battery generally includes an electrode assembly comprising a positive electrode and a negative electrode, a case accommodating the electrode assembly, and electrode terminals connected to the electrode assembly.

Cases for secondary batteries used in small electronic devices is mainly made of metal materials such as aluminum alloy. But there may be problems in that the cases of such secondary batteries can be damaged due to complex factors during various manufacturing processes. For example, during a pressing/drawing process to form a can that is a secondary battery case, thickness variations in a flange part of the can may cause welding defects when joining the cover to the can.

A secondary battery with high energy density (the amount of energy stored per unit volume) may provide a longer running time in small electronic device or a longer driving range in electric vehicles. Therefore, the energy density of the secondary battery may be one of the most important factors that determine the performance of the secondary battery.

The material of the case generally has a high strength, so there is a limit to ensuring formation depth during the drawing process of the can that is the case. The radius of curvature of the edge of the can may be large, which imposes a limit to increasing the energy density of the secondary battery.

The information disclosed in this section is for the enhancement of understanding of the background of the present disclosure, it may contain information that does not constitute prior art.

### SUMMARY

The present disclosure provides a secondary battery a case for secondary battery and a method of manufacturing the secondary battery for solving the technical problems described above. However, the technical problems to be solved by the present disclosure is not limited to the above-described problems. Other problems not mentioned herein, and aspects and features of the present disclosure that would address such problems, will be clearly understood by those skilled in the art from the description of the present disclosure below.

According to embodiments of the present disclosure, there is provided a case for secondary battery, including a body including an opening at one end and an accommodating space configured to accommodate an electrode assembly, and a cover coupled to body to cover the opening and seal the accommodating space, wherein the body includes tin in an amount of 0.1 wt % or more and 0.5 wt % or less with respect to a total weight of the body.

The body may include a body base including a bottom and a side wall that extends vertically from the bottom, and a body flange extended outward from the body base and coupled to the cover.

An edge of the body base may be curved shape to have a radius of curvature.

A size of the radius of curvature may be 0.5 mm to 4.0 mm.

The body flange may be bonded to at least part of the cover by laser welding.

A thickness of the body may be 0.04 mm to 0.2 mm.

The body may include chromium in an amount of 13 wt % or more and 18 wt % or less with respect to the total weight of the body.

The cover may include tin in an amount of 0.1 wt % or more and 0.5 wt % or less with respect to a total weight of the cover.

According to embodiments of the present disclosure, there is provided a secondary battery including a body including an opening at one end and an accommodating space, an electrode assembly accommodated in the accommodating space, the electrode assembly including a first electrode, a separator, and a second electrode, and a cover coupled to the body to cover the opening and seal the accommodating space, wherein the body includes tin in an amount of 0.1 wt % or more and 0.5 wt % or less with respect to a total weight of the body.

The body may include a body base including a bottom and a side wall that vertically extends from the bottom, and a body flange extended outward from the body base and coupled to the cover.

An edge of the body base may be curved to have a radius of curvature.

A size of the radius of curvature may be 0.5 mm to 4.0 mm.

A thickness of the body may be 0.04 mm to 0.2 mm.

The body may include chromium in an amount of 13 wt % or more and 18 wt % or less with respect to the total weight of the body.

The cover may include tin in an amount of 0.1 wt % or more and 0.5 wt % or less with respect to a total weight of the cover.

According to embodiments of the present disclosure, there is provided a method of manufacturing a secondary battery, the method including forming a flat plate shaped body containing tin in an amount of 0.1 wt % or more and 0.5 wt % or less with respect to a total weight, shaping the body to form an accommodating space, inserting an electrode assembly into the accommodating space through an opening of the body, and coupling a cover to the body to cover the opening.

The body may include a body base including a bottom and a side wall that vertically extends from the bottom, and a body flange extending outward from the body base, and the cover may be coupled to the body flange.

At least part of the cover may be bonded to the body flange by laser welding.

An edge of the body base may be curved to a radius of curvature of 0.5 mm to 4.0 mm.

The cover may include tin (Sn) in an amount 0.1 wt % or more and 0.5 wt % or less with respect to the total weight of the cover.

According to embodiments of the present disclosure, the body constituting the case includes tin in an amount of 0.1 wt % to 0.5 wt % with respect to the total weight of the body, which improves the formability of the body and prevents thickness variation that may otherwise occur during the process of forming the body flange. The flatness of the body flange may be ensured, thereby resolving the problem of welding defects during the coupling of the body and the cover.

According to embodiments of the present disclosure, the body includes tin in an amount of 0.1 wt % or more and 0.5 wt % or less with respect to the total weight of the body and the radius of curvature of the edge of the body base is made as small as possible. Thus, the size of the accommodating space for accommodating the electrode assembly within the body base may be maximized, thereby maximizing the energy density of the secondary battery.

According to embodiments of the present disclosure, the formability of the body may be enhanced, thereby preventing cracks that otherwise occur during the deep-drawing formation. As a result, it is possible to maintain the rigidity of the case for secondary battery.

However, aspects and features of the present disclosure are not limited to those described above, and other aspects and features not mentioned will be clearly understood by a person skilled in the art from the detailed description.

### BRIEF DESCRIPTION OF DRAWINGS

The drawings illustrate embodiments of the present disclosure and further describe aspects and features of the present disclosure together with the detailed description of the present disclosure. The present disclosure is not limited to the embodiments depicted in the drawings.

FIG. 1 is an exploded perspective view of a secondary battery according to embodiments of the present disclosure;

FIG. 2 is a perspective view of a secondary battery according to embodiments of the present disclosure;

FIG. 3 is an exploded perspective view of a case for secondary battery according to embodiments of the present disclosure;

FIG. 4 is a perspective view of a crack in a case for secondary battery according to a comparative example;

FIG. 5 is a cross-sectional view of secondary battery according a comparative example;

FIG. 6 is a perspective view of a case for secondary battery according to embodiments of the present disclosure;

FIG. 7 illustrates a radius of curvature in a case for a secondary battery according to embodiments of the present disclosure;

FIG. 8 is a cross-sectional view taken along line A-A of the body base of FIG. 6;

FIG. 9 is a perspective view of a body for explaining a formation depth according to embodiments of the present disclosure;

FIG. 10 is a cross-sectional view of a thickness of a body according to embodiments of the present disclosure; and

FIG. 11 is a flowchart of a method for manufacturing a secondary battery according to embodiments of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terminology used herein is for the purpose of describing embodiments of the present disclosure and is not intended to be limiting of the present disclosure.

In this specification, singular expressions include plural expressions unless the context clearly specifies singular expressions. In addition, plural expressions include singular expressions unless the context clearly specifies plural expressions. Throughout the specification, when a part is described as including a component, additional components may also be included unless specifically stated to the contrary.

According to embodiments of the present disclosure, the sizes and the relative sizes of layers and areas illustrated in the drawings may be exaggerated for clarity of explanation. The sizes in the drawings are only for ease of explanation, and the present disclosure is not limited thereto. Like reference numerals in the drawings denote like elements throughout the specification.

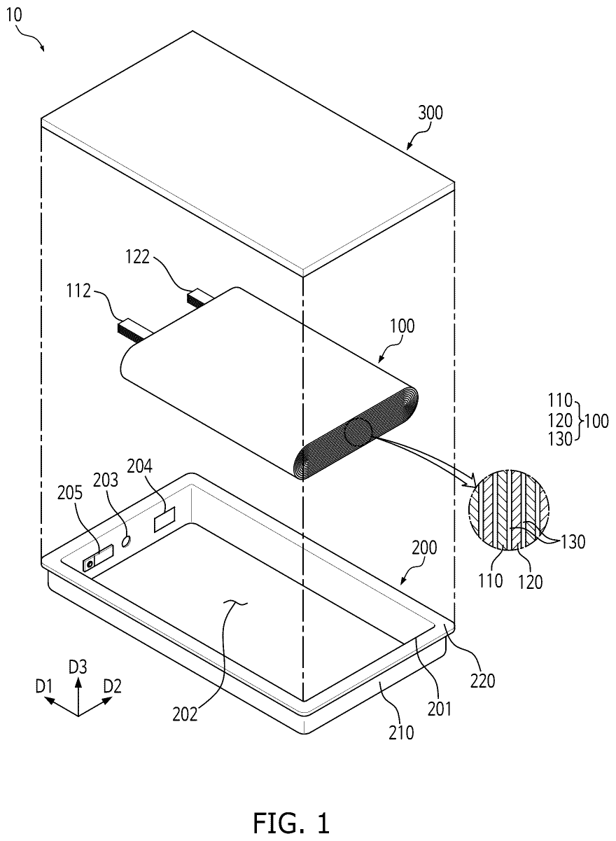

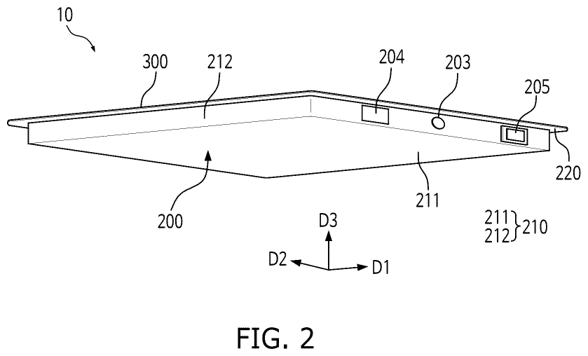

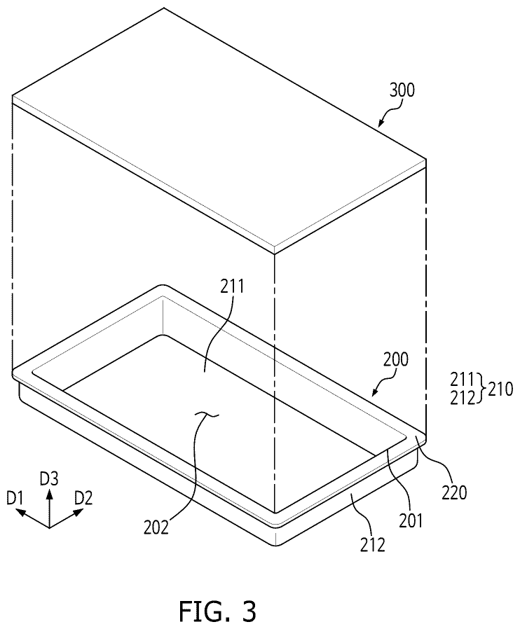

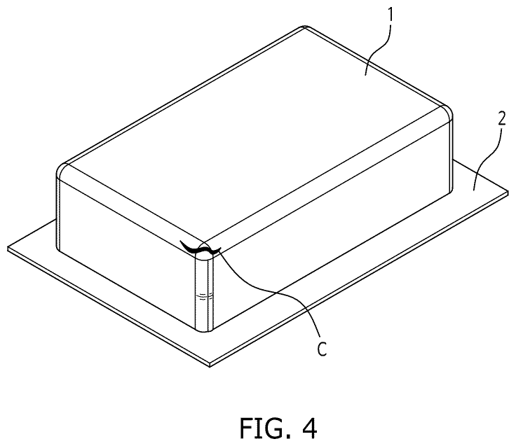

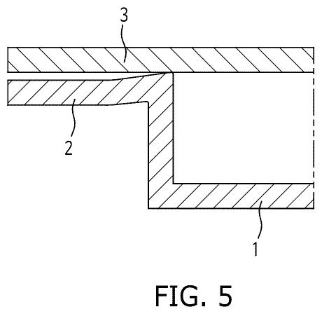

FIG. 1 is an exploded view of a secondary battery according to embodiments of the present disclosure, FIG. 2 is a perspective view of a secondary battery according to embodiments of the present disclosure, FIG. 3 is an exploded perspective view of a case for secondary battery according to embodiments of the present disclosure, FIG. 4 is a perspective view showing an example where a crack occurs in a case for secondary battery according to a comparative example, and FIG. 5 is a cross-sectional view illustrating a case for secondary battery according to a comparative example.

D1, D2 and D3 illustrated in FIG. 1 may indicate the length direction, width direction and thickness direction of a secondary battery 10 or components of the secondary battery 10 (e.g., body 200, electrode assembly 100, etc.).

Referring to FIG. 1 to FIG. 3, the secondary battery 10 may include an electrode assembly 100, a body 200 including an accommodating space 202 for accommodating the electrode assembly 100, and a cover 300 coupled to the body 200. The electrode assembly 100 may include a first electrode 110, a separator 130, and a second electrode 120. The electrode assembly 100 may be wound or stacked with the separator 130, which is an insulator, disposed between the first electrode 110 and the second electrode 120.

More specifically, the electrode assembly 100 may include the first electrode 110, the separator 130, and the second electrode 120. The electrode assembly 100 may be wound or stacked with the separator 130, which is an insulator, disposed between the first electrode 110 and the second electrode 120. The first electrode 110 may include a first substrate and a first active material layer disposed on the first substrate. A first electrode tab 112 may extend outward from a first non-coated part of the first substrate where the first active material layer is not provided. The second electrode 120 may include a second substrate and a second active material layer disposed on the second substrate. A second electrode tab 122 may extend outward from a second non-coated part of the second substrate where the second active material layer is not provided.

The first electrode 110 may function as a positive electrode, with the first substrate being a positive electrode substrate. The positive electrode substrate may be formed of aluminum foil, and the positive electrode active material may include, for example, a transition metal oxide.

The positive electrode active material may include a compound (lithiated intercalation compound) that is capable of intercalating and deintercalating lithium. In some examples, at least one of a composite oxide of lithium and a metal selected from cobalt, manganese, nickel, and combinations thereof may be used.

The composite oxide may be a lithium transition metal composite oxide. Specific examples of the composite oxide may include lithium nickel-based oxide, lithium cobalt-based oxide, lithium manganese-based oxide, lithium iron phosphate-based compound, cobalt-free nickel-manganese-based oxide, or a combination thereof. In particular, the following compounds represented by any one of the following Chemical Formulas may be used: LiaA1-bXbO2-cDc (0.90≤a≤1.8, 0≤b≤0.5, and 0≤c≤0.05); LiaMn2-bXbO4-cDc (0.90≤a≤1.8, 0≤b≤0.5, and 0≤c≤0.05); LiaNi1-b-cCobXcO2-αDα (0.90≤a≤1.8, 0≤b≤0.5, 0≤c≤0.5, and 0<α<2); LiaNi1-b-cMnbXcO2-αDα (0.90≤a≤1.8, 0≤b≤0.5, 0≤c≤0.5, and 0<α<2); LiaNibCocL1dGeO2 (0.90≤a≤1.8, 0≤b≤0.9, 0≤c≤0.5, 0≤d≤0.5, and 0≤e≤0.1); LiaNiGbO2 (0.90 ≤a≤1.8 and 0.001≤b≤0.1); LiaCoGbO2 (0.90≤a≤1.8 and 0.001≤b≤0.1); LiaMn1-bGbO2 (0.90≤a≤1.8 and 0.001≤b≤0.1); LiaMn2GbO4 (0.90 ≤a≤1.8 and 0.001≤b≤0.1); LiaMn1-gGgPO4 (0.90≤a≤1.8 and 0≤g≤0.5); Li(3-f)Fe2(PO4)3 (0≤f≤2); or LiaFePO4(0.90≤a≤1.8). In these Chemical Formulas, A is Ni, Co, Mn, or a combination thereof; X is Al, Ni, Co, Mn, Cr, Fe, Mg, Sr, V, a rare earth element or a combination thereof; D is O, F, S, P, or a combination thereof; G is Al, Cr, Mn, Fe, Mg, La, Ce, Sr, V, or a combination thereof; and L1 is Mn, Al, or a combination thereof.

The positive electrode active material may be, for example, a high nickel-based positive electrode active material having a nickel amount of greater than or equal to about 80 mol %, greater than or equal to about 85 mol %, greater than or equal to about 90 mol %, greater than or equal to about 91 mol %, or greater than or equal to about 94 mol % and less than or equal to about 99 mol %, based on 100 mol % of the metal excluding lithium in the lithium transition metal composite oxide. The high-nickel-based positive electrode active material may provide high capacity and can be applied to a high-capacity, high-density rechargeable lithium battery.

The second electrode 120 may function as a negative electrode, with the second substrate may be a negative electrode substrate. The negative electrode substrate may be made of, for example, copper foil or nickel foil, and the negative electrode active material may include, for example, graphite.

The negative electrode active material may include a material that reversibly intercalates/deintercalates lithium ions, a lithium metal, a lithium metal alloy, a material capable of doping/dedoping lithium, or a transition metal oxide. The material that reversibly intercalates/deintercalates lithium ions may include a carbon-based negative electrode active material, such as, for example. crystalline carbon, amorphous carbon or a combination thereof. The crystalline carbon may be graphite such as non-shaped, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOx (0<x<2), a Si-Q, and a combination thereof. In the formula Si-Q, Q is selected from an alkali metal, an alkaline-earth metal, a Group 13 element, a Group 14 element (excluding Si), a Group 15 element, a Group 16 element, a transition metal, a rare earth element, and a combination thereof. The Sn-based negative electrode active material may include Sn, SnO2, a Sn-based alloy, or a combination thereof.

The silicon-carbon composite may be a composite of silicon and amorphous carbon. The silicon-carbon composite may be in a form of silicon particles and amorphous carbon coated on the surfaces of the silicon particles. For example, the silicon-carbon composite may include secondary particles (core) in which primary silicon particles are assembled, and an amorphous carbon coating layer (shell) on the surfaces of the secondary particles. The amorphous carbon may also be between the primary silicon particles, and, for example, the primary silicon particles may be coated with the amorphous carbon. The secondary particle may exist dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si-based negative electrode active material or the Sn-based negative electrode active material may be used in combination with a carbon-based negative electrode active material.

The separator 130 may include polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like.

The separator may include a porous substrate and a coating layer including an organic material, an inorganic material, or a combination thereof on one or both surfaces of the porous substrate.

The porous substrate may be a polymer film formed of a polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON®, and polytetrafluoroethylene, or a copolymer or mixture of two or more thereof.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof. But the present disclosure is not limited thereto.

The organic material and the inorganic material may be mixed in one coating layer. In other examples, a coating layer may be formed by stacking layer of an organic material and a layer including an inorganic material.

An opening 201 may be formed at one end of the body 200 (e.g., one end of the body 200 in a D3 direction). The body 200 may accommodate the electrode assembly 200 inserted into the body 200 through the opening 210. The body 200 may include one open end and an accommodating space 202 for accommodating the electrode assembly 100.

The body 200 may include a body base 210 with a body flange 220 extending outward from the body base 210. The body flange 220 may be coupled to the cover 300. The body base 210 may include a bottom 211 and a side wall 212 vertically extending from the body 211. When the bottom 211 has a diagonal shape, the bottom 211 may include a plurality of side walls 212 corresponding to a plurality of sides (edges) of the bottom 211.

The bottom 211 of the body base 210 may be various shapes. For example, the bottom 211 may have a square shape. As such, the side wall 212 may be formed by surrounding four (4) sides of the bottom 211 having a square shape. In another example, the bottom 211 may have a circular shape, with the side wall 212 surrounding the circumference of the bottom 211.

The bottom 211 may be bent to form the side wall 212. For example, the side wall 212 may extend from the bottom 211 by bent in the D3 direction shown in FIG. 1. The side wall 212 may be formed to surround the bottom 211. In one embodiment, the side wall 212 may be formed as four (4) walls that extend from the bottom 211 in the D3 direction. A negative electrode terminal 204 and a positive electrode terminal 205 may be disposed on at least one surface of the side wall 212.

The body 200 may include the space 202 for accommodating the electrode assembly 100 around the center area by a press processing, a drawing processing, etc. The body flange 220 may extend outward in four directions at the top edge of the accommodating space 202. The body flange 220 may extend outward from the body base 210 and may be coupled to the cover 300. The electrode assembly 100 may be inserted into the opening 201 of the body 200 to be accommodated in the accommodating space 202. The cover 303 may be coupled to the opening 201 of the body 200 to seal the accommodating space 202.

The body 200 may include tin (Sn) in an amount of 0.1 wt % or more and 0.5 wt % or less with respect to the total weight of the body 200. The body 200 may include chromium (Cr) in an amount of 13 wt % or more and 18 wt % or less with respect to the total weight of the body 200. By including tin and chromium, it is possible to prevent cracks from occurring by the relatively high stress concentrated at the edges of the body base 210 during formation of the body 200, while also reducing the manufacturing cost of the case for the secondary battery.

Referring to FIGS. 4 and 5, the case for secondary battery according to the comparative example may have high strength but low formability due to the absence or inclusion of tin (Sn) in a small amount. As such, a crack C may occur in a body base 1 of the body.

For example, as shown in FIG. 5, when the hardness of the body base 1 and the body flange 2 is excessively high, stress may be concentrated in the edge area of the body base 1 during a press/drawing process for forming the body, and the body flange 2 may rise or thicken. As shown in FIG. 5, when the cover 3 is bonded after the body flange 2 of the edge of the body base 1 has arisen, the welding defect between the body and the cover may occur.

For secondary batteries that include various forms of SUS cans, the flatness of the body flange 2 for welding quality of the body and the cover may be a key. The SUS material according to the comparative example may have excellent rigidity. But during the formation process the flatness of the flange is distorted, and it may be difficult to correct the flatness by a restriking process. Particularly, during the pressing/drawing process, the edge of the body base 1 that is structurally disadvantaged due to a relatively high load, may have a thickness that is increased in the portion where the radius of curvature is formed in the process of forming the body flange 2. This thickness deviation may cause the welding defect with the cover 3.

According to embodiments of the present disclosure, the body 200 may have improved formability by including tin (Sn) in an amount of 0.1 wt % or more and 0.5 wt % or less based on the total weight of the body 200. Accordingly, the thickness variation occurring during the process of forming the body base 210 and the body flange 220 may be prevented. The flatness of the body flange 220 may be secured, thereby solving the problem of welding defects that occur in the coupling between the body 200 and the cover 300.

The body 200 may be formed to include the body base 210 and the body flange 220 during a drawing formation process. And the body base 210 may form the accommodating space 202 for accommodating the electrode assembly.

The body 200 may include tin (Sn) in an amount of 0.1 wt % or more and 0.5 wt % or less based on the total weight of the body 200, which prevents cracks from occurring due to relatively high stress being concentrated on the edge of the body base 210 during formation. For example, stress may be prevented from being concentrated on the edge areas of the body flange 220 during the drawing formation process of the body 200. Accordingly, the material in the edge area of the body flange 220 may be prevented from increasing due to a lack of space to be pushed out, thereby ensuring the flatness of the body flange 220.

The body 200 may include the negative electrode terminal 204 and the positive electrode terminal 205 on a side surface that are different from side of the body 200 that is open. The body 200 may include an electrolyte injection hole 203. For example, the electrolyte injection hole 203 may be a through hole formed in the side surface of the body 200. An electrolyte may be injected into the inside of the body 200 of the secondary battery 10 through the injection hole 203 after the body 200 and the cover are bonded and sealed.

The electrolyte injection hole 203 may be sealed by a sealing member after an electrolyte is injected. The electrolyte injection hole 203 is illustrated as being disposed between a pair of electrode terminals. But the present disclosure is not limited to this example, and the electrolyte injection hole 203 may be provided at other positions. The pair of electrode terminals may be arranged on the side surface of the body 200. For example, the negative electrode terminal 204 and the positive electrode terminal 205 may be disposed on both sides in a D2 direction with respect to the electrolyte injection hole 203 as shown in FIG. 1.

The positive electrode terminal 205 may be electrically connected to a first electrode tab 112 of the electrode assembly 100, and the negative electrode terminal 204 may be electrically connected to a second electrode tab 122 of the electrode assembly 100. The positions of the positive electrode terminal 205 and the negative electrode terminal 204 are not limited to the positions shown in FIG. 1 and may be provided at other positions in other examples.

The cover 300 may be coupled to the body 200. For example, the cover 300 may be coupled to cover the opening 201, and may seal the accommodating space 202. The body 200 may be bonded to the cover 300 to form the exterior of the secondary battery 10. In an example, the cover 300 is formed of a flat plate arranged on the top of the body 200 to seal the accommodating space 202. The cover 300 may be formed of a flat plate having a size to cover the body flange 220, thereby being contactable with the body flange 220.

The body flange 220 may be bonded to at least part of the cover 300 by laser welding. For example, the body 200 and the cover 300 may be bonded by metal bonding (e.g., welding, brazing, soldering, etc.). In such embodiments, the body flange 220 of the body 200 may be bonded to the edge of the cover 300. After the body 200 is bonded to the cover 300, at least part of the body flange 220 may be cut by using the laser to enhance energy density.

The cover 300 may include tin (Sn) of 0.1 wt % or more and 0.5 wt % or less based on the total weight of the cover 300, and the body 200 and the cover 300 may be made of the same metallic material. By forming the body 200 and the cover 300 of the same material, corrosion at the portion where the body 200 is bonded to the cover 300 that would otherwise be cause by using different metals is prevented.

The cover 300 may include stainless steel (stainless steel, SUS). For example, the stainless steel material of the cover 300 may be SUS 304, SUS 316, SUS 420, or SUS 430, depending on the type and ratio of the alloy material within the stainless steel series.

The secondary battery 10 may be a lithium battery cell, a sodium battery cell, etc. However, the scope of the present disclosure is not limited with respect to the type of the battery. The secondary battery 10 includes all types of batteries that may repeatedly provide electricity by charging and discharging. When the secondary battery 10 is a lithium secondary battery, the lithium secondary battery may be used in an electric vehicle (EV) because of its excellent life characteristics and high-rate characteristics. For example, the lithium secondary battery may be used in a hybrid vehicle such as a plug-in hybrid electric vehicle (PHEV). In other examples, the lithium secondary battery may be used in fields that require a wide range of power storage such as smartphones, tablet PCs, electric bicycles, power tools, etc.

The configuration of the secondary battery illustrated in FIG. 1 is merely exemplary. According to some embodiments, other components may be additionally included or omitted. The shape, positional relationship, etc. of each component of the secondary battery illustrated in FIG. 1 may vary.

According to embodiments of the present disclosure, the body 200 may be bonded to the cover 300 by laser welding. However, the bonding method in the present disclosure is not limited, and various bonding methods may be used for sealing the body 200. For example, the body 200 and the cover 300 may be metal-bonded (e.g., welding, brazing, soldering, etc.). As another example, the body 200 and the cover 300 may be bonded through a separate adhesive layer. The adhesive layer may include at least one of hot melt, rubber, or acrylic. When the adhesive layer includes a hot melt adhesive, the hot melt adhesive may include an acrylic resin, a synthetic rubber resin, a polyolefin resin, an ester resin, a urethane resin, an epoxy resin, or a silicone resin. But the present disclosure is not limited thereto. For example, the film may be impregnated with the hot melt adhesive by applying a molten hot melt adhesive solution to the film layer or by impregnating the film layer with a hot melt adhesive solution dissolved in a solvent and then volatilizing the solvent. However, the present disclosure is not limited thereto, and various impregnation methods of the hot melt adhesive may be used.

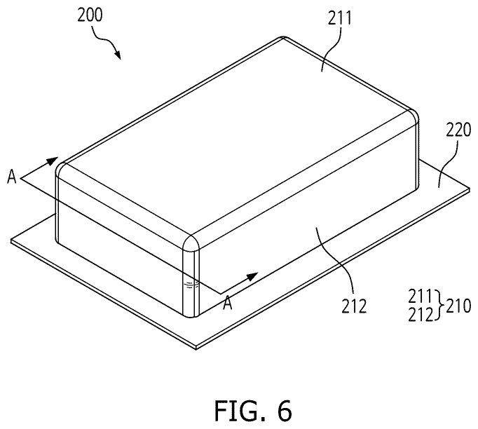

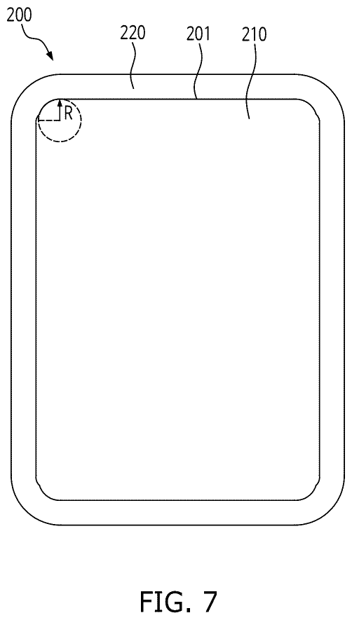

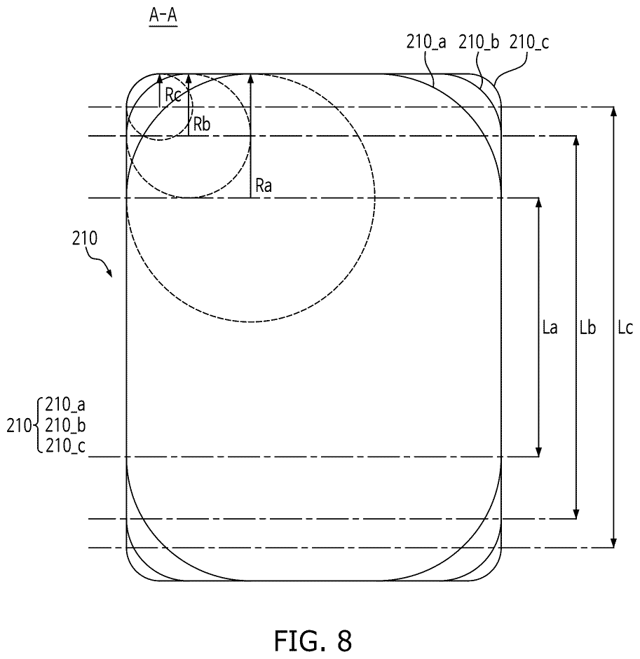

FIG. 6 is a perspective view of a case for secondary battery according to embodiments of the present disclosure. FIG. 7 illustrates a radius curvature of a body, and FIG. 8 is a view taken along line A-A of the body base of FIG. 6.

Referring to FIG. 6 to FIG. 8, the edge of the body base 210 may be formed into a curved shape having a radius curvature R. In some examples, the size of the radius curvature R may be from 0.5 mm to 4.0 mm. The body 200 may be formed to include the body base 210 with the opening 201 and the body flange 220 in the drawing formation process. And the body base 210 may include the bottom 211 and the side wall 212.

In the drawing forming process of the body 200, the body 200 may include tin (Sn) in an amount of 0.1 wt % or more and 0.5 wt % or less with respect to the total weight of the body 200. Such a configuration improves the formability and minimizes the curvature radius R as much as possible.

Referring to FIG. 8, various examples of the body base 210 are illustrated. Specifically, each of three (3) body bases 210 may have the edge with the same vertical and horizontal lengths, but the body bases 210 have different radiuses of curvature.

According to a first example, a body base 210_a may be formed with a curved surface having an edge with a radius of curvature Ra that connects side walls. In a second example, a body base 210_b the edge that connects the side walls has a radius of curvature Rb. In a third example, a body base 210_c the edge that connects the side walls has a radius of curvature Rc. The radius of curvature Ra may be greater than the radius of curvature Rb, and the radius of curvature Rb may be greater than the radius of curvature Rc.

Referring to FIG. 8, as the radius curvature increases, the size of the accommodating space that accommodates the electrode assembly inside the body base 210 is reduced. For example, a vertical length La of the accommodating space of the body base 210_a having the radius of curvature Ra is less than a vertical length Lb of the accommodating space of the body base 210_b having the radius of curvature Rb. The vertical length Lb of the accommodating space of the body base 210_b having the radius of curvature Rb is less than the vertical length Lc of the accommodating space of the body base 210_c having the radius of curvature Rc. Therefore, decreasing the radius of curvature R increases the accommodating space inside the body base 210, and thereby improves the energy density of the secondary battery.

According to embodiments of the present disclosure, the body 200 may include tin (Sn) in an amount of 0.1 wt % or more and 0.5 wt % or less with respect to the total weight of the body 200 thereby improving formability, while the radius of curvature R is minimized as much as possible. Accordingly, the electrode assembly accommodating space inside the body base 210 may be increased, and the energy density of the secondary battery may be improved.

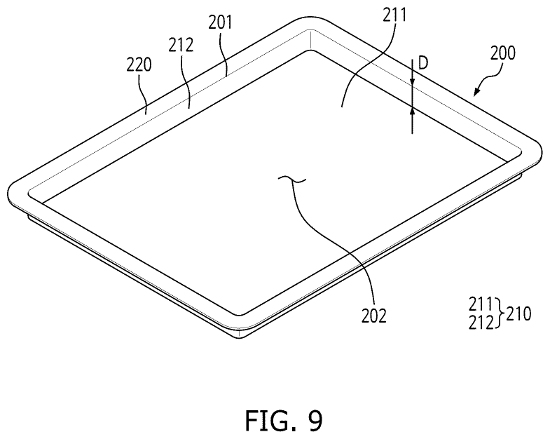

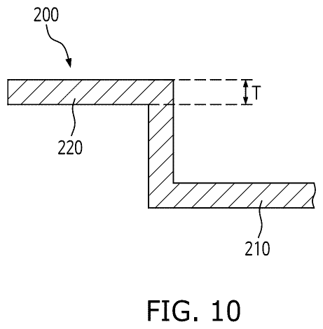

FIG. 9 is a perspective view of a body and illustrates a formation depth according to embodiments of the present disclosure. FIG. 10 is a cross-sectional of a body according to embodiments of the present disclosure.

A thickness T of the body 200 may be 0.04 mm or more and 0.2 mm or less. The body 200 may be formed to include the body base 210 with the opening 201 and the body flange 220 in the formation process. And the body base 210 may include the bottom 211 and the side wall 212.

To enhance the energy density of the secondary battery, a formation depth D of the body base 210 is increased. But, as a result, cracks may occur. Also, reducing the radius curvature of each edge of the body base 210 to increase the energy density of the secondary battery may cause cracks to occur. but, according to embodiments of the present disclosure, the body 200 may include tin (Sn) of 0.1 wt % or more and 0.5 wt % or less with respect to the total weight of the body 200, thereby making the body 200 more formable. Thus, the energy density of the secondary battery may be increased by improving the forming depth (D), and cracks that would otherwise occur in the body base 210 may be prevented.

In some examples, the body 200 may includes tin (Sn) of 0.1 wt % or more and 0.5 wt % or less with respect to the total weight of the body 200, thereby improving the body's formability, and the may be made flat as illustrated in FIG. 10. When the cover is coupled to the body 200, welding defects, etc. may be prevented, thereby improving the quality of the secondary battery.

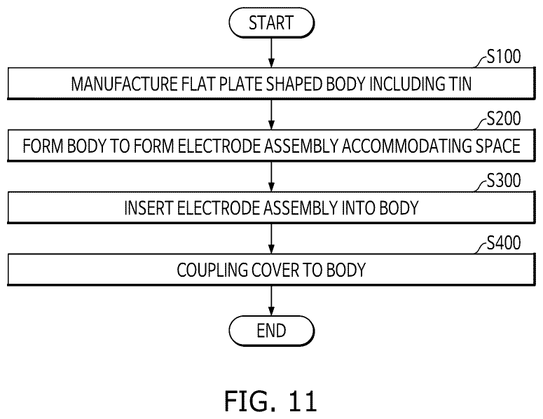

FIG. 11 is a flowchart of a method of manufacturing a secondary battery according to embodiments of the present disclosure.

A method of manufacturing a secondary battery may initiate by preparing a flat plate-shaped body in step S100. Referring to FIG. 11, a method of manufacturing the secondary battery may include the step of manufacturing a flat plate-shaped body in step S100, the step of forming a body in step S200, the step of inserting an electrode assembly into a body in step S300, and the step of bonding a cover to a body in step S400.

The step of manufacturing a body in step S100 may include manufacturing a flat-plate shaped body including tin (Sn) of 0.1 wt % or more and 0.5 wt % or less with respect to the total weight. The step of manufacturing a body in step S100 improves the formability of the body including tin (Sn) of 0.1 wt % or more and 0.5 wt % or less with respect to the total weight before the step of forming the body in step S200.

After step S100, the step of forming the body may be performed in step in S200. The step of forming the body in step S200 may include the step of shaping the body to form the accommodating space.

In the step of forming the body in step S200, the body may be made to include a body base including a bottom and a side wall that vertically extends from the bottom, and a body flange extended outward from the body base and bonded to the cover. In some embodiments, in the step of forming the body in step S200, the edge of the body base may be curved shape with a radius curvature between 0.5 mm and 4.0 mm.

After the step of forming the body in step S200, the step of inserting an electrode assembly into a body may be performed in step S300. In this step, the electrode assembly is inserted into an accommodating space through an opening of a body.

The step of bonding the cover to the body in step S400 may be the step of bonding the cover to the opening of the body. In the step of bonding the cover in step S400, at least part of the cover may overlap the body flange and be joined by laser welding. The body may include tin (Sn) of 0.1 wt % or more and 0.5 wt % or less with respect to the total weight, so that the flatness of the body flange may be secured. When the cover is coupled to the body, welding defects, etc. may be avoided, thereby securing the quality of the secondary battery.

According to embodiments of the present disclosure, the \ cover may include tin (Sn) in an amount of 0.1 wt % or more and 0.5 wt % or less with respect to the total weight may be further included prior to the step of bonding the cover to the body in step S400. The body and the cover may be formed with the same material so that corrosion at the portion where the body and the cover are bonded is prevented.

The flowchart of FIG. 11 and the above description are merely examples of the present disclosure. The scope of the present disclosure is not limited to the flowchart of FIG. 11 and the above description. For example, one or more steps in the flowchart and the above description may be added/changed/deleted, the order of one or more steps may be changed, or one or more steps may be performed simultaneously.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure.

### Description of Notations

10: Secondary Battery
100: Electrode Assembly
200: Body
201: Opening
202: Accommodating Space
210: Body Base
211: Bottom
212: Side Wall
220: Body Flange
300: Cover

What is claimed is:

1. A case for secondary battery comprising:
a body including an opening at one end and an accommodating space configured to accommodated an electrode assembly; and
a cover coupled to body to cover the opening and seal the accommodating space,
wherein the body includes tin in an amount of 0.1 wt % or more and 0.5 wt % or less with respect to a total weight of the body.

2. The case for secondary battery as claimed in claim 1, wherein the body comprises:
a body base including a bottom and a side wall that extends vertically from the bottom; and
a body flange extended outward from the body base and coupled to the cover.

3. The case for secondary battery as claimed in claim 2, wherein an edge of the body base is curved to have a radius of curvature.

4. The case for secondary battery as claimed in claim 3, wherein the radius of curvature is 0.5 mm to 4.0 mm.

5. The case for secondary battery as claimed in claim 2, wherein the body flange is bonded to at least part of the cover by laser welding.

6. The case for secondary battery as claimed in claim 1, wherein a thickness of the body is 0.04 mm to 0.2 mm.

7. The case for secondary battery as claimed in claim 1, wherein the body includes chromium in an amount of 13 wt % or more and 18 wt % or less with respect to the total weight of the body.

8. The case for secondary battery as claimed in claim 1, wherein the cover includes tin in an amount of 0.1 wt % or more and 0.5 wt % or less with respect to a total weight of the cover.

9. A secondary battery comprising:
a body including an opening at one end and an accommodating space
an electrode assembly accommodated in the accommodating space, the electrode assembly including a first electrode, a separator, and a second electrode;
a cover coupled to the body to cover opening and seal the accommodating space,
wherein the body includes tin in an amount of 0.1 wt % or more and 0.5 wt % or less with respect to a total weight of the body.

10. The secondary battery as claimed in claim 9, wherein the body comprises,
a body base including a bottom and a side wall that vertically extends from the bottom; and
a body flange extended outward from the body base and coupled to the cover.

11. The secondary battery as claimed in claim 10, wherein an edge of the body base is curved to have a radius of curvature.

12. The secondary battery as claimed in claim 11, wherein a size of the radius of curvature is 0.5 mm to 4.0 mm.

13. The secondary battery as claimed in claim 9, wherein a thickness of the body is 0.04 mm to 0.2 mm.

14. The secondary battery as claimed in claim 9, wherein the body includes chromium in an amount of 13 wt % or more and 18 wt % or less with respect to the total weight of the body.

15. The secondary battery as claimed in claim 9, wherein the cover includes tin in an amount of 0.1 wt % or more and 0.5 wt % or less with respect to a total weight of the cover.

16. A method of manufacturing a secondary battery, the method comprising:
forming a flat plate-shaped body comprising it in an amount of 0.1 wt % or more and 0.5 wt % or less with respect to a total weight of the body;
shaping the body to form an accommodating space;
inserting an electrode assembly into the accommodating space through an opening of the body; and
coupling a cover to the body to cover the opening.

17. The method as claimed in claim 16, wherein the body comprises a body base including a bottom and a side wall that vertically extends from the bottom, and a body flange extending outward from the body base and
wherein the cover is couples to the body flange.

18. The method as claimed in claim 17, wherein at least part of the cover is bonded to the body flange by laser welding.

19. The method as claimed in claim 17, wherein an edge of the body base is curved to a radius of curvature of 0.5 mm to 4.0 mm.

20. The method as claimed in claim 16, wherein the cover comprises tin in an amount 0.1 wt % or more and 0.5 wt % or less with respect to a total weight of the cover.
